(19) United States
(12) Patent Application Publication
(10) Pub. No.: US 2012/0179709 A1
(43) Pub. Date: Jul. 12, 2012

(54) APPARATUS, METHOD AND PROGRAM PRODUCT FOR SEARCHING DOCUMENT

(76) Inventors: Wataru NAKANO, Kanagawa-ken (JP); Toshihiko MANABE, Kanagawa-ken (JP); Tomoharu KOKUBU, Kanagawa-ken (JP); Masumi INABA, Tokyo (JP)

(21) Appl. No.: 13/341,185

(22) Filed: Dec. 30, 2011

(30) Foreign Application Priority Data
Jan. 11, 2011 (JP) P2011-003439

(51) Int. Cl. G06F 17/30

(52) U.S. Cl. 707/769; 707/E17.008; 707/E17.014

(57) ABSTRACT

A document searching system of an embodiment comprises a storage device storing structured document data, extracted phrase information of phrases in the structured document data which includes an identifier of the extraction-source structured document data containing each of the phrases and includes an attribute of each of the phrases in the extraction-source structured document data, and a mode determination rule including a search mode and a display format for each attribute. The document searching system of this embodiment inputs a search phrase, determines an attribute of the search phrase with reference to the extracted phrase information if the extracted phrase information contains a phrase matching the search phrase, determines a search mode for searching the structured document data and a display format of a search result with reference to the mode determination rule based on the determined attribute.

### CROSS-REFERENCE TO RELATED APPLICATION

This application is based upon and claims the benefit of priority from Japanese Patent Application No. 2011-003439, filed on Jan. 11, 2011, the entire contents of which are incorporated herein by reference.

### FIELD

Embodiments of the present invention relate to a apparatus, method and program product for searching document background.

With the widespread of the electronic documents and the World Wide Web (abbreviated as WWW), document searches are widely utilized in daily life and various business operations.

For example, using Internet search services, a user can collect information described in Web pages all over the world only by inputting a keyword. Further, document searches are also utilized in systems for documentation management and information sharing in companies and government offices, tools for personal information arrangement, and the like other than services for searching on the Internet.

A document search is executed by inputting a search query such as a keyword. As an output result of the document search, for example, a list of document titles is outputted. The user selects a document of interest from the outputted document list to review the contents thereof, thus acquiring information.

For example, in call centers, an operator searches for a past case by a document search. If the labor needed for this search is small, i.e., if the document search can be efficiently performed, the operator can answer an inquiry with reference to a relevant past case. Accordingly, work efficiency can be improved.

There are some methods of reducing the procedure and labor of a document search to improve work efficiency. In one of these methods, a service for searching on the Internet is provided with buttons not only for executing a search process for outputting search results in a list format, but also for directly displaying the content of a document ranked number one in search results. However, this method is effective only in the case where the user knows in advance that the document ranked number one in the search results is a correct document.

Further, there is another method in which Web sites matching the keyword inputted as the search query are recommended on the basis of Web search logs. In this method, Web sites frequently referred to in the past searches are determined based on the inputted keyword, and the Web sites are recommended in a balloon or similar format upon completion of inputting the keyword before the search process is executed.

With this method, documents which describe information wanted by the user can be recommended immediately after the completion of inputting the search query. However, this method is only usable in Web searches, and is effective only in environments where a vast number of operational logs are available. In other words, this method does not effectively function in searches on intra-company and individual documents in which a vast number of operational logs are not expected unlike in Web searches. Further, the user needs to fully input the keyword as the search query.

### BRIEF DESCRIPTION OF THE DRAWINGS

Aspects of this disclosure will become apparent upon reading the following detailed description and upon reference to the accompanying drawings. The description and the associated drawings are provided to illustrate embodiments of the invention and not limited to the scope of the invention.

FIG. 1 is a view showing one example of the overall configuration of a document searching system according to a first embodiment.

FIG. 2 is a view showing one example of a search screen in the document searching system according to the first embodiment.

FIG. 3 is a view showing one example of document data in the document searching system according to the first embodiment.

FIG. 4 is a view showing one example of document structure information in the document searching system according to the first embodiment.

FIG. 5 is a view showing one example of extracted phrase information in the document searching system according to the first embodiment.

FIG. 6 is a view showing one example of a mode determination rule table in the document searching system according to the first embodiment.

FIG. 7 is a flowchart showing one example of a document search process in the document searching system according to the first embodiment.

FIG. 8 is a flowchart showing one example of a mode determination process in the document searching system according to the first embodiment.

FIG. 9 is a view showing one example of a search result screen outputted to an output unit of the document searching system according to the first embodiment.

FIG. 10 is a view showing one example of a search result screen outputted to an output unit of the document searching system according to the first embodiment.

FIG. 11 is a view showing one example of the overall configuration of a document searching system according to a second embodiment.

FIG. 12 is a view showing one example of a search mode designation screen in a document searching system according to the second embodiment.

FIG. 13 is a view showing one example of a search mode designation region in a document searching system according to the second embodiment.

FIG. 14 is a view showing one example of the overall configuration of a document searching system according to a third embodiment.

FIG. 15 is a flowchart showing one example of a query selection process in a document searching system according to the third embodiment.

FIG. 16 is a view showing one example of icons in the document searching system according to the third embodiment.

FIG. 17 is a view showing one example of a search screen in the document searching system according to the third embodiment.

FIG. 18 is a view showing one example of a search screen in the document searching system according to a fourth embodiment.

FIG. 19 is a flowchart showing one example of a query candidate creation process in a document searching system according to the fourth embodiment.

FIG. 20 is a flowchart showing one example of a query selection process in a document searching system according to the fourth embodiment.

### DETAILED DESCRIPTION

A document searching system of this embodiment includes a storage device for storing structured document data, extracted phrase information containing an identifier of extraction-source structured document data of each of phrases contained in the structured document data and an attribute of the phrase in the extraction-source structured document data, and a mode determination rule including a search mode and a display format for each attribute. Further, the document searching system of this embodiment receives a search phrase, determines, if there is a phrase matching the search phrase in the extracted phrase information, an attribute of the search phrase with reference to the extracted phrase information, refers to the mode determination rule based on the determined attribute to determine a search mode for searching the structured document data and a display format of search results, performs a document search based on the search phrase in the determined search mode, and outputs the search results in the determined display format.

Hereinafter, embodiments of the present invention will be described with reference to the drawings.

### Description of the First Embodiment

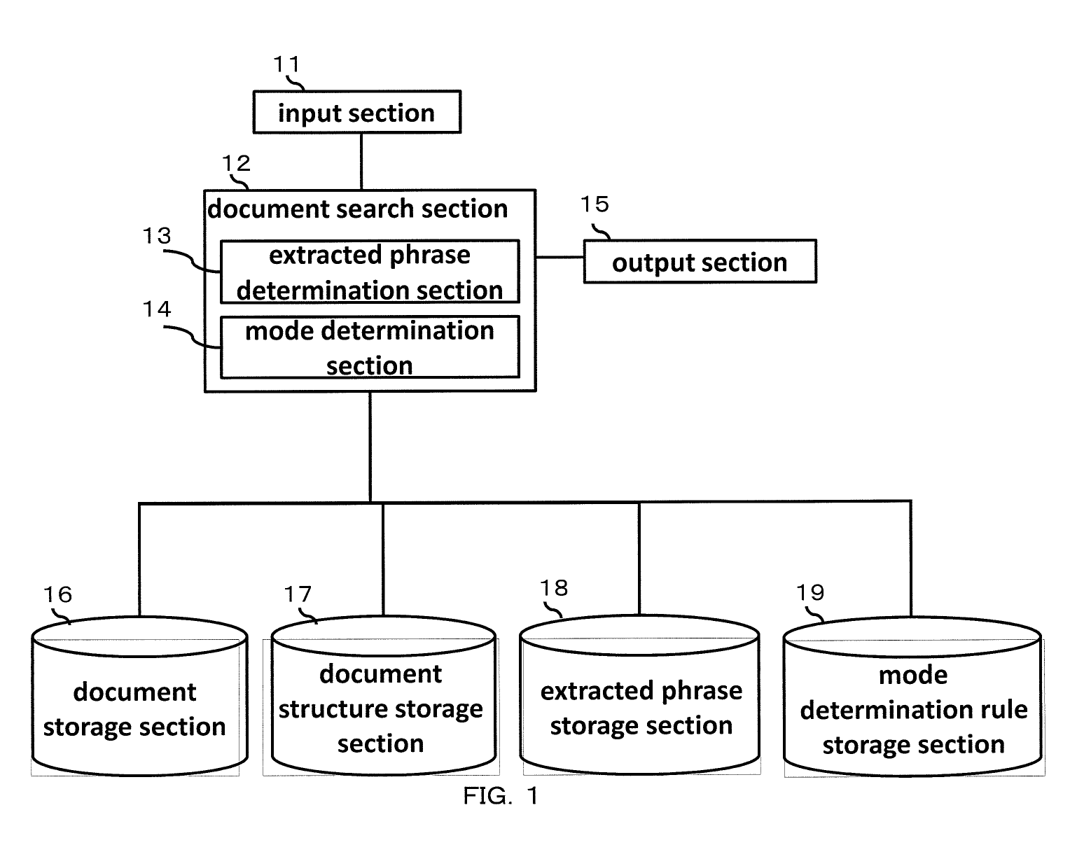

FIG. 1 shows the overall configuration of a document searching system according to a first embodiment of the present invention.

The document searching system of this embodiment includes an input unit 11, a document search unit 12, an output unit 15, a document storage unit 16, a document structure storage unit 17, an extracted phrase storage unit 18, and a mode determination rule storage unit 19.

The input unit 11 is used to input a character string as a search query. In other words, a character string inputted by a user using the input unit 11 is sent as a search query to the document search unit 12 to perform a document search. The input unit 11 has, for example, a keyboard and a mouse, and is used by the user to provide an input and an instruction. Specifically, an input character string inputted by the user using the keyboard is displayed in an input screen displayed on a display, and a “send” button on the input screen is clicked with the mouse included in the input unit 11 to send the input character string to the document searching system of this embodiment.

The document search unit 12 converts the character string inputted through the input unit 11 (hereinafter referred to as an input character string) to a search query, and searches document data stored in the document storage unit 16 based on this search query. The document search unit 12 includes an extracted phrase determination unit 13 and a mode determination unit 14.

The extracted phrase determination unit 13 determines whether or not the input character string is stored in the extracted phrase storage unit 18. The mode determination unit 14 determines a search mode and a display format based on the result of the determination by the extracted phrase determination unit 13.

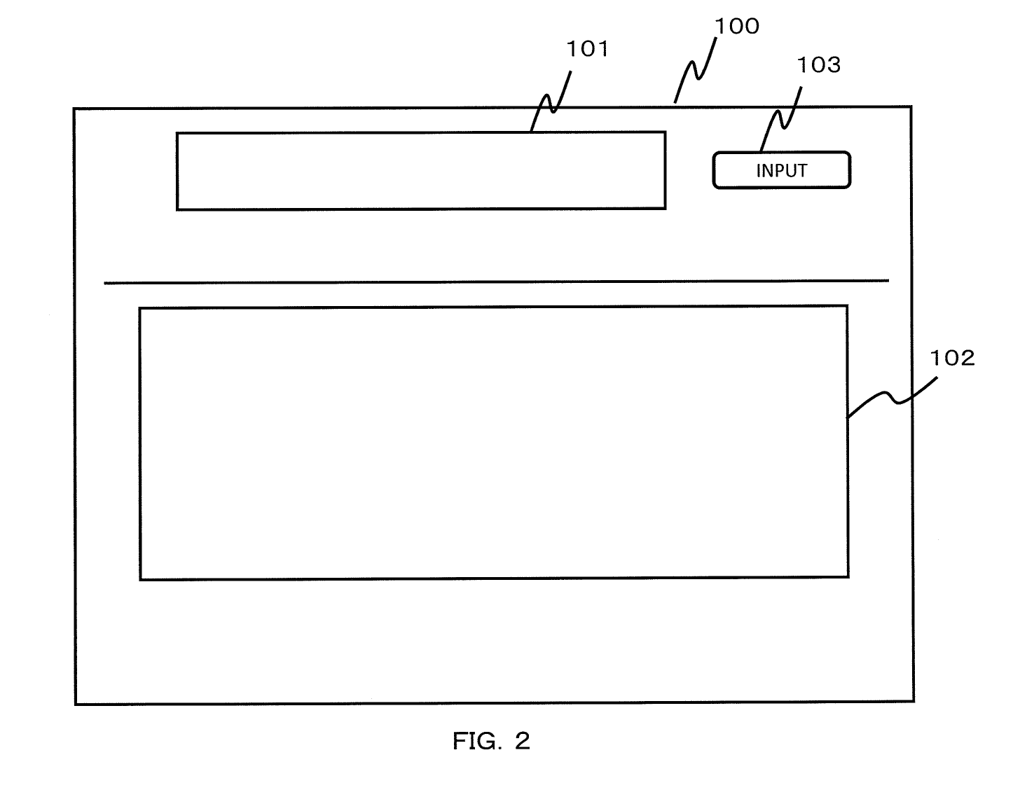

For example, in the case where the input character string is a phrase stored in the later-described extracted phrase storage unit 18, the document search unit 12 determines a search mode and a display format based on attributes of the phrase stored in the extracted phrase storage unit 18. The document search unit 12 searches the document data in the document storage unit 16, based on the determined search mode. Further, based on the determined display format, search results are outputted to the output unit 15. The output unit 15 is a display device, e.g., a liquid crystal display or the like. It should be noted that the liquid crystal display as the output unit 15 displays a search screen 100 beforehand. One example of the search screen 100 is shown in FIG. 2.

As shown in FIG. 2, the search screen 100 has an input form 101 for inputting a search query, a search result display area 102, and an input button 103. The character string which is the search query inputted by the user using the input unit 11 is displayed in the input form 101. When the input button 103 is clicked with the mouse included in the input unit 11, the character string is inputted to the document search unit 12, and a document search is performed. The search result display area 102 displays results of the document search.

The document storage unit 16 stores document data to be searched by the document searching system and structure information on the document data. In other words, the document data stored in the document storage unit 16 is data containing structure information by tagging. Further, the document data stored in the document storage unit 16 includes data on, for example, Web page documents, office documents, patent publications, and the like. In this embodiment, the document storage unit 16 stores document data in a form in which structure information on a document is expressed in XML (Extensible Markup Language).

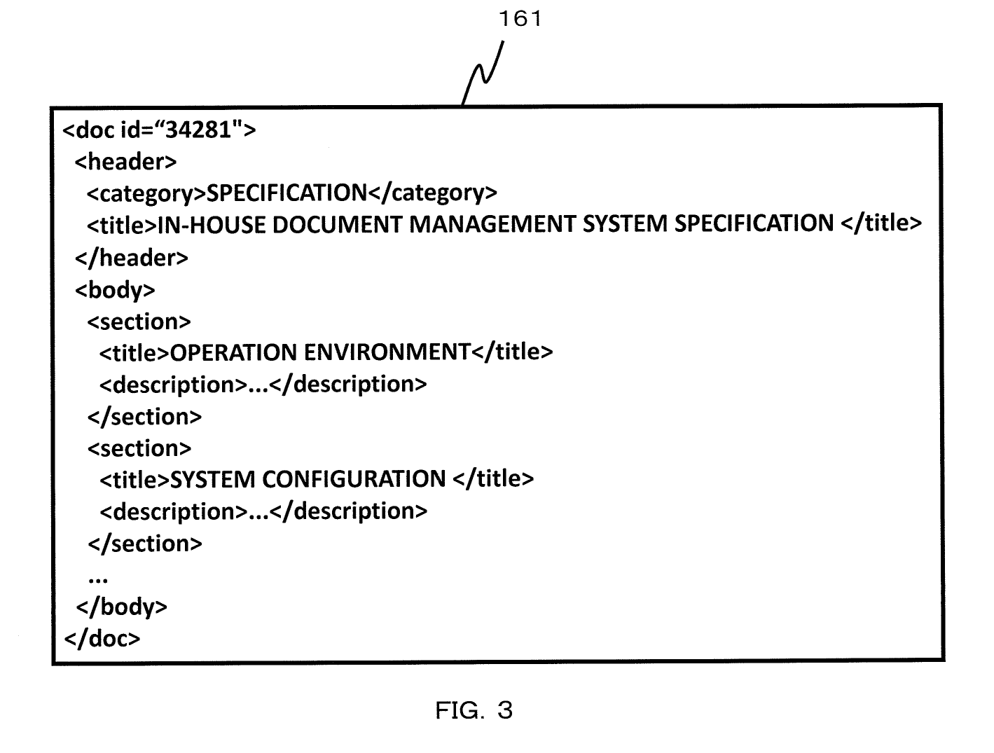

FIG. 3 shows one example of the document data stored in the document storage unit 16. As to the document data shown in FIG. 3, the document ID thereof is 34281, and elements thereof are “/doc/header/category,” “/doc/header/title,” “/doc/body/section/title,” and “/doc/body/section/description.”

The expression “/doc/header/category” represents the category of the document data. The expression “/doc/header/title ” represents the title of the document data. The expression “/doc/body/section/title” represents a section title of the document data. The expression “/doc/body/section/description” represents the description of a section of the document data. In other words, the document data of this embodiment is classified by category.

The document structure storage unit 17 stores document structure information including element information and attribute information. The element information indicates elements of the document data stored in the document storage unit 16. The attribute information indicates the attributes of the elements.

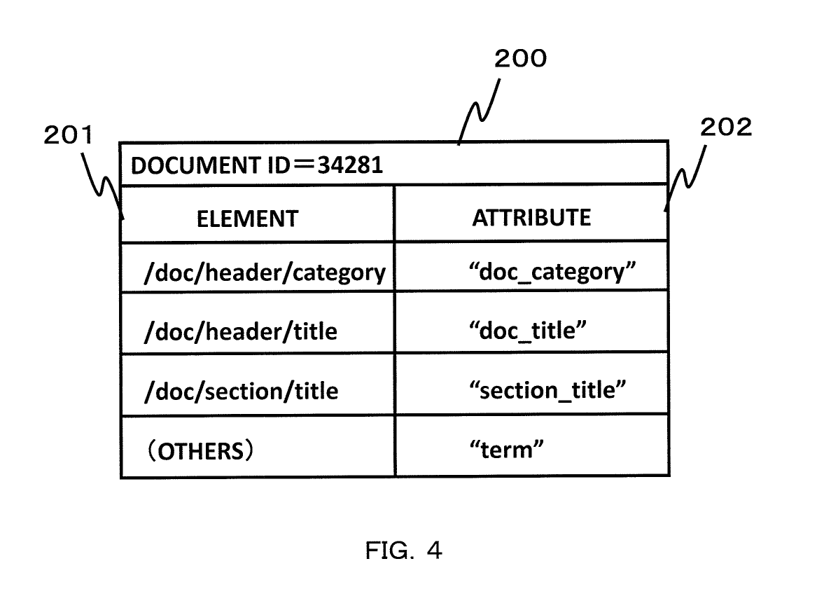

FIG. 4 shows one example of the document structure information 200 stored in the document structure storage unit 17. It should be noted that the document structure information is stored in accordance with data on each document, i.e., document IDs.

The document structure information 200 shown in FIG. 4 includes elements 201 of data on a document and attributes 202 to be assigned to phrases extracted from each element. It should be noted that “term” is the attribute of phrases in portions to which no element is assigned. For example, since the element “/doc/body/section/description” of the document data shown in FIG. 3 is not included in the elements of the document structure information, the attribute of phrases occurring in the element “/doc/body/section/description” is “term.”

The extracted phrase storage unit 18 stores a phrase extracted from the document data stored in the document storage unit 16 (hereinafter referred to as an extracted phrase), in association with the document ID of extraction source document data (hereinafter referred to as an extraction source document) and the attribute. This attribute is associated with the phrase based on the element of the extracted phrase with reference to the document structure information shown in FIG. 4.

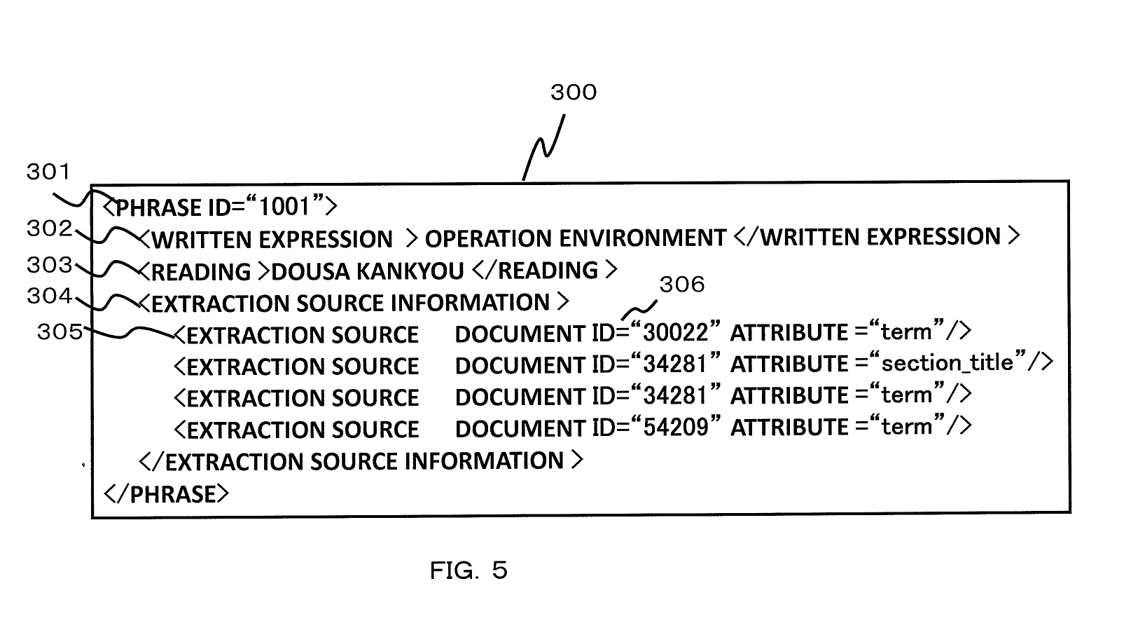

FIG. 5 shows one example of extracted phrase information 300 stored in the extracted phrase storage unit 18. As shown in FIG. 5, the extracted phrase information 300 includes a “phrase ID” 301 for identifying an extracted phrase, “written expression” 302 and “reading” 303 of the extracted phrase, and extraction source information 304. The extraction source information 304 includes “document ID” 305 of each extraction source and “attribute” 306 of the extracted phrase in this extraction source document.

FIG. 5 shows four pairs of document IDs 305 and attributes 306 as the extraction source information 304 on a phrase of which phrase ID 301 is “1001,” of which written expression 302 is “operation environment,” and of which reading 303 is “DOUSA KANKYOU.” It should be noted that the reading 303 is assigned by performing morphological processing on the extracted phrase and combining per-morpheme readings registered in a morphological analysis dictionary.

It should be noted that extracted phrases stored in the extracted phrase storage unit 18 are extracted in advance from the document data stored in the document storage unit 16 by an unillustrated phrase extraction section. This phrase extraction section extracts the extracted phrases from the document data stored in the document storage unit 16 with reference to the document structure information in the document structure storage unit 17.

For example, the phrase extraction section refers to the elements of the document structure information, and extracts character strings occurring in the elements as extracted phrases without any change. Alternatively, the phrase extraction section may perform various extractions such as morphological analysis, semantic information extraction, compound word extraction, and named entity extraction. Alternatively, the phrase extraction section may select a specific type of results from extraction results of morphological analysis, semantic information extraction, compound word extraction, and the like. Alternatively, the phrase extraction section may extract not only a phrase itself but also the word class, semantic attribute name, and reading of the phrase, information on the document in which the phrase occurs, and the like in combination.

Further, the phrase extraction section performs another search on the document data in the document storage unit 16 for the extracted phrase extracted as described above. In other words, the phrase extraction section searches for document data in which each extracted phrase occurs, other than document data in which an attribute is assigned to the extracted phrase. If there are documents in which the extracted phrase occurs, the phrase extraction section stores all pairs (document ID, attribute) of document IDs and attributes as the extraction source information 304 in the extracted phrase information 300.

The mode determination rule storage unit 19 stores a mode determination rule 400. The mode determination rule 400 is used to perform a document search process by the document search unit 12.

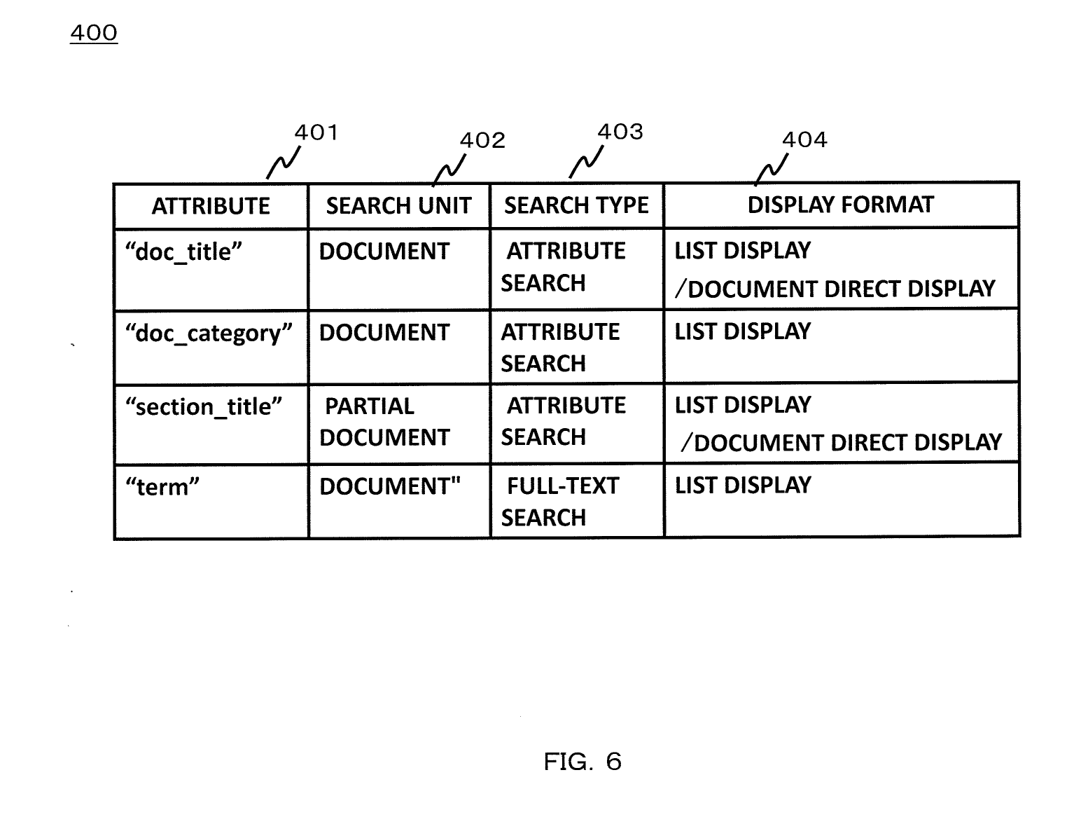

FIG. 6 shows one example of the mode determination rule 400. As shown in FIG. 6, the mode determination rule 400 indicates a search unit 402, a search type 403, and a display format 404 for each attribute 401. The search unit 402 and the search type 403 are collectively referred to as a search mode.

The search unit 402 is a unit to be used when the document search unit 12 performs a search. The search unit 402 is, for example, “document” or “partial document.” If the search unit 402 is “document, ” the document search unit 12 performs a search in units of a document. If the search unit 402 is “partial document, ” the document search unit 12 performs a search in units of each of the elements in the document data. For example, in the case where structured document data having a structure including chapters and sections is searched, if the search unit 402 is “partial document , ” the document search unit 12 performs a search in units of each of the chapters and sections of the document data.

The search type 403 indicates the type of the search mode.

The search type 403 is, for example, “attribute search” or “full-text search.” If the search type 403 is “attribute search,” the document search unit 12 searches for document data in which a specific portion of the document data corresponding to the attribute or part of bibliographic information matches a search phrase. If the search type 403 is “full-text search,” the document search unit 12 searches for document data containing the search phrase anywhere in the document.

The display format 404 indicates the format of output to the output unit 15. The display format 404 is, for example, “list display” or “document direct display.” If the display format 404 is “list display,” the document search unit 12 displays a list of titles of document data on the output unit 15. If the display format 404 is “document direct display,” the document search unit 12 displays contents of data on the documents in the search results on the output unit 15.

It should be noted that the document storage unit 16, the document structure storage unit 17, the extracted phrase storage unit 18, and the mode determination rule storage unit 19 may be stored in an identical storage device or a plurality of storage devices. The storage devices are, for example, hard disks or flash memories.

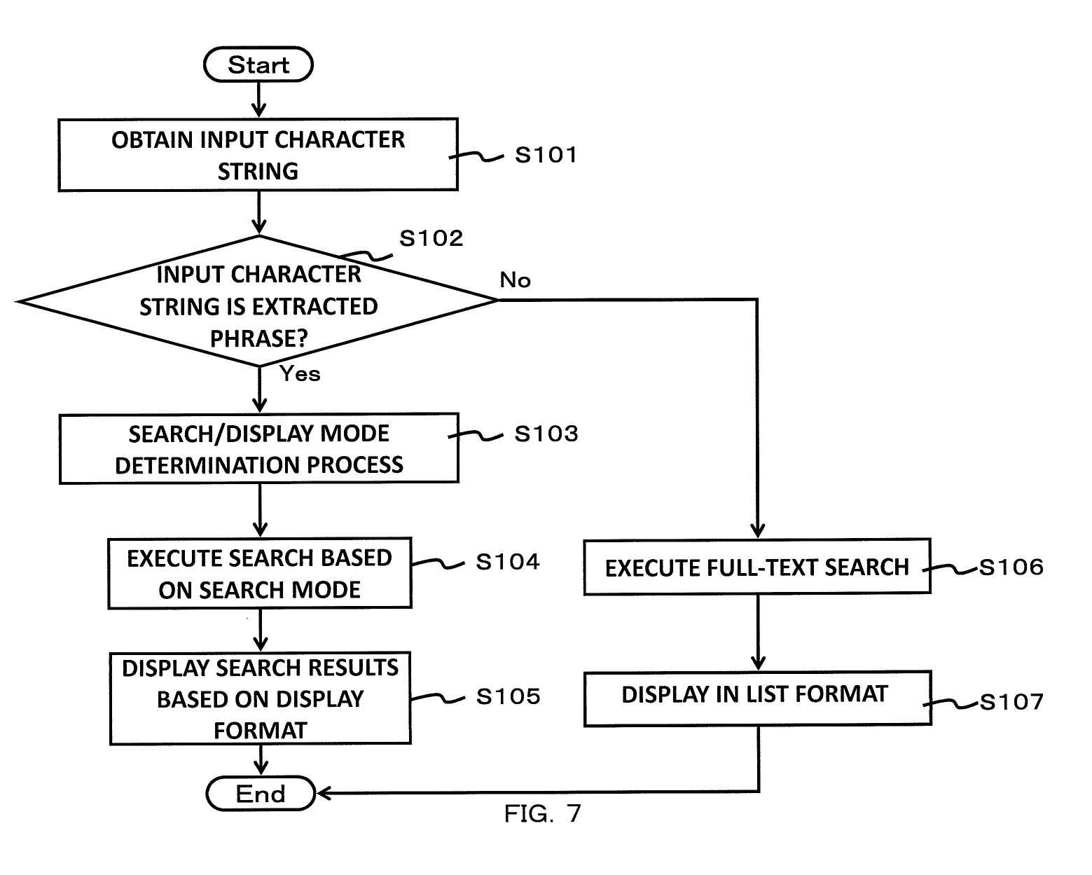

Referring now to FIGS. 7 to 10, the document search process in the document searching system of this embodiment will be described. The document searching system described below stores in the document storage unit 16 data on structured documents such as specifications and reports released in an organization such as a company, and searches this structured document data based on a search query from the user to output search results.

Specifically, the document storage unit 16 is implemented as an XML database. Further, in the document search unit 12, a search query is created based on an input character string which is the search query. It should be noted that the search query is created in XQuery, which is a query language for XML databases. The document search unit 12 searches the document data in the document storage unit 16, based on the created search query. Further, when the document search process is started, a search query screen 100 of FIG. 2 is being displayed on the liquid crystal display as the output unit 15. In an input field 101 of the search query screen 100, “in-house document management system specification” is being displayed which is the character string inputted by the user.

FIG. 7 is a flowchart showing the operation of the document searching system of this embodiment at the time of outputting search results in response to the search query by the user.

First, the document input unit 11 obtains the input character string inputted by the user (step S101). Specifically, when the user has clicked the input button 103 using the mouse as the input unit 11, the character string displayed in the input field 101 is inputted to the document search unit 12. In this example, the input character string “in-house document management system specification” is inputted to the document search unit 12.

When the document search unit 12 has obtained the input character string, the extracted phrase determination unit 13 of the document search unit 12 determines whether or not this input character string is stored in the extracted phrase storage unit 18 (step S102). In other words, the extracted phrase determination unit 13 performs a search as to whether or not the extracted phrase storage unit 18 stores an extracted phrase matching the input character string.

If the input character string is stored in the extracted phrase storage unit 18 (Yes in step S102), the mode determination unit 14 performs a mode determination process (step S103).

Specifically, the mode determination unit 14 makes a determination as to the search mode including the search unit 402 and the search type 403 and the display format 404 with reference to the extracted phrase information on an extracted phrase matching the input character string and the mode determination rule 400 stored in the mode determination rule storage unit 19. This mode determination process will be described later.

Based on the result of the search mode determination in step S103, the document search unit 12 executes a document search on the document data group stored in the document storage unit 16 (step S104) . When the search has been completed, search results are displayed on the output unit 15 based on the display format 404 determined in step S103 (step S105), and the document search process is ended.

If the input character string is not stored in the extracted phrase storage unit 18 (No in step S102), the document search unit 12 executes a “full-text search” in “units of a document” on a group of document data stored in the document storage unit 16 (step S106). When the search has been completed, the output unit 15 displays search results in a list format (step S107), and the document search process is ended.

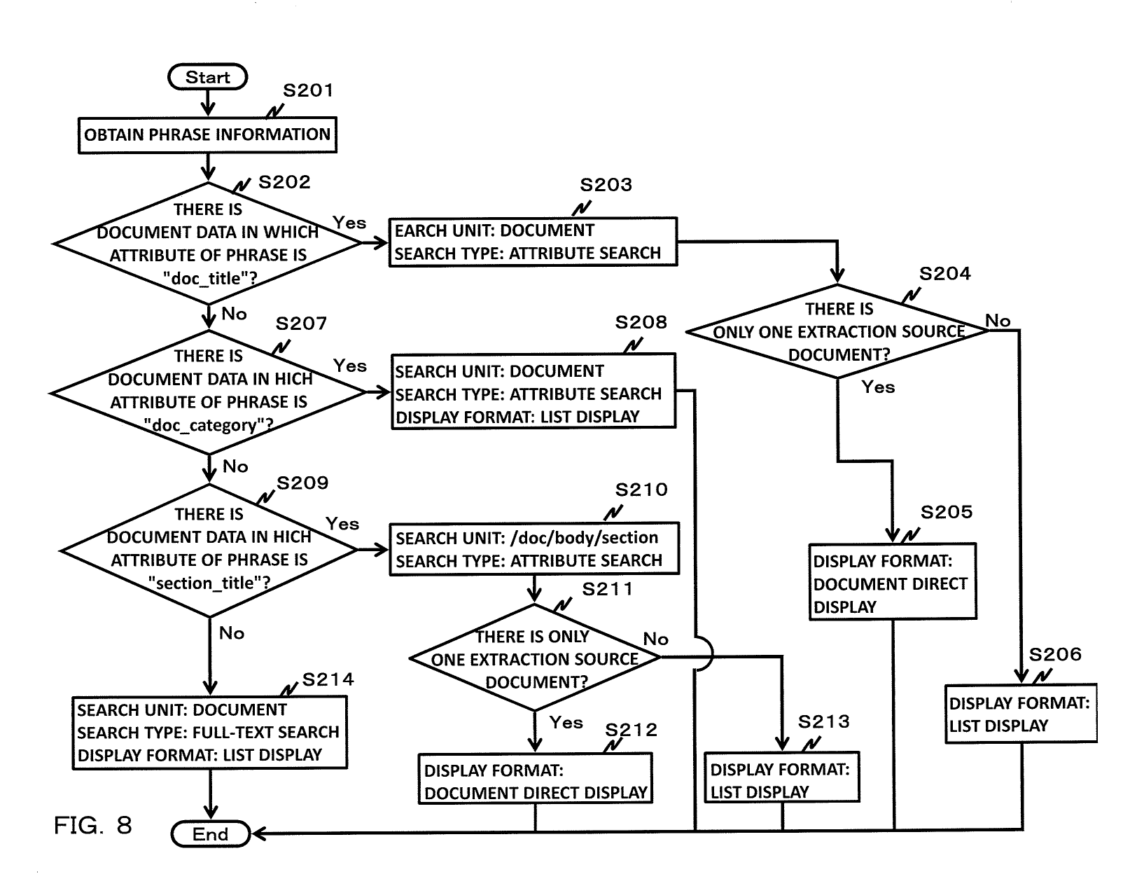

Referring now to the flowchart shown in FIG. 8, the mode determination process by the document search unit 12 in step S103 of FIG. 7 will be described. FIG. 8 is a flowchart showing one example of the mode determination process by the document search unit 12.

First, based on the input character string inputted in step S101 of FIG. 7, the document search unit 12 obtains from the extracted phrase storage unit 18 the extracted phrase information 300 on a phrase matching the input character string (step S201). Subsequently, the extracted phrase determination unit 13 of the document search unit 12 determines a representative attribute of the input character string based on the attributes 306 of the extracted phrase.

Specifically, based on the extraction source information 304 contained in the extracted phrase information 300 obtained in step S201, the extracted phrase determination unit 13 of the document search unit 12 determines whether or not the attributes 306 of the extracted phrase include “doc_title” (step S202). It should be noted that in the case where the obtained extracted phrase information 300 is extracted phrase information on a phrase extracted from data on a plurality of documents, i.e., in the case where the extracted phrase information 300 on the obtained phrase has a plurality of extraction source document IDs 305, if the attribute 306 of the extracted phrase in document data indicated by any one of the extraction source document IDs 305 contained in the extracted phrase information 300 is “doc title,” the extracted phrase determination unit 13 determines that the attribute of the input character string is “doctitle.”

If the attribute 306 of the extracted phrase information 300 obtained in step S201 is “doc_title” (Yes in step S202), the mode determination unit 14 refers to the mode determination rule 400 based on the attribute 306, and decides the search unit 402 and the search type 403 (step S203). In this example, since the attribute 306 is “doc_title, ” the mode determination unit 14 sets the search unit 402 and the search type 403 to “document” and “attribute search”, respectively.

Subsequently, the mode determination unit 14 determines the display format of the search results with reference to the mode determination rule 400. Specifically, first, the mode determination unit 14 determines whether or not there is only one extraction source document in which the attribute of the phrase is “doc_title” (step S204).

If there is only one extraction source document in which the attribute of the phrase is “doc_title” (Yes in step S204), the mode determination unit 14 selects “document direct display” of the mode determination rule 400 (step S205), and ends the mode determination process.

If there are two or more extraction source documents in which the attribute of the phrase is “doc_title” (No in step S204), the mode determination unit 14 selects “list display” of the mode determination rule 400 (step S206), and ends the mode determination process.

If the attribute of the phrase is not “doc_title” (No in step S202), the extracted phrase determination unit 13 determines whether or not the attribute of the phrase is “doc category” (step S207). It should be noted that in the case where a phrase of interest is a phrase extracted from data on a plurality of documents, i.e., there are two or more extraction source document IDs contained in the phrase information on the phrase of interest, if the attribute of the phrase in data on any one of the documents is “doc_category,” the attribute of the phrase is determined to be “doc_category.”

If the attribute of the phrase is “doc_category” (Yes in step S207), the mode determination unit 14 refers to the mode determination rule 400 based on the attribute of the phrase, and decides the search unit, the search type, and the display format (step S208). Specifically, since the attribute of the phrase is “doc_{—} category,” the mode determination unit 14 sets the search unit, the search type, and the display format to document, attribute search, and list display, respectively. Then, the mode determination process is ended.

If the attribute of the phrase is not “doc_category” (No in step S207), the extracted phrase determination unit 13 determines whether or not the attribute of the phrase is “section_title” (step S209). It should be noted that in the case where obtained phrase information is phrase information extracted from a plurality of documents, i.e., there are two or more extraction source document IDs contained in the obtained phrase information, if attributes indicating “section_title” form a predetermined proportion or more of all the attributes of the phrase in data on the documents, the attribute of the phrase is determined to be “section_title”. In other words, if data on documents in which the attribute is “section title” forms less than the predetermined proportion of the data on the documents contained in the phrase information, the extracted phrase determination unit 13 provides “No” in step S209. It should be noted that this predetermined proportion is set in advance.

If the attribute of the phrase is “section_title” (Yes instep S209), the mode determination unit 14 refers to the mode determination rule 400 based on the attribute of the phrase, and decides the search unit and the search type (step S210). Here, the mode determination unit 14 sets the search unit and the search type, to “/doc/body/section” and attribute search, respectively.

The mode determination unit 14 determines the display format of the search results with reference to the mode determination rule 400. Specifically, since the display format indicated by the mode determination rule 400 is “list display” or “document direct display,” first, a determination is made as to whether or not there is only one extraction source document in which the attribute of the phrase is “section_title” (step S211).

If there is only one extraction source document in which the attribute of the phrase is “section_title” (Yes in step S211), the mode determination unit 14 selects “document direct display” of the mode determination rule 400 (step S212), and ends the mode determination process. In this case, based on the result of the mode determination process, the output unit directly displays the phrase searched for, /doc/body/section/title of data on the document in which the attribute “section_title” is assigned to the phrase, and the element/doc/body/sect ion of the phrase.

If there are two or more extraction source documents in which the attribute of the phrase is “section_title” (No in step S211), the mode determination unit 14 selects “list display” of the mode determination rule 400 (step S213), and ends the mode determination process. In this case, based on the result of the mode determination process, the output unit 15 directly displays as a search result a list of searched documents in which the attribute “section_title” is assigned to the phrase. It should be noted that when the displayed document is selected by the user, /doc/body/section/title may present the element/doc/body/section of the phrase.

If the attribute of the phrase is not “section_title” (No in step S209), the mode determination unit 14 determines the attribute of the phrase to be “term.” Then, the mode determination unit 14 refers to the mode determination rule 400 based on this attribute “term,” and decides the search unit, the search type, and the display format (step S214). The mode determination unit 14 ends the mode determination process.

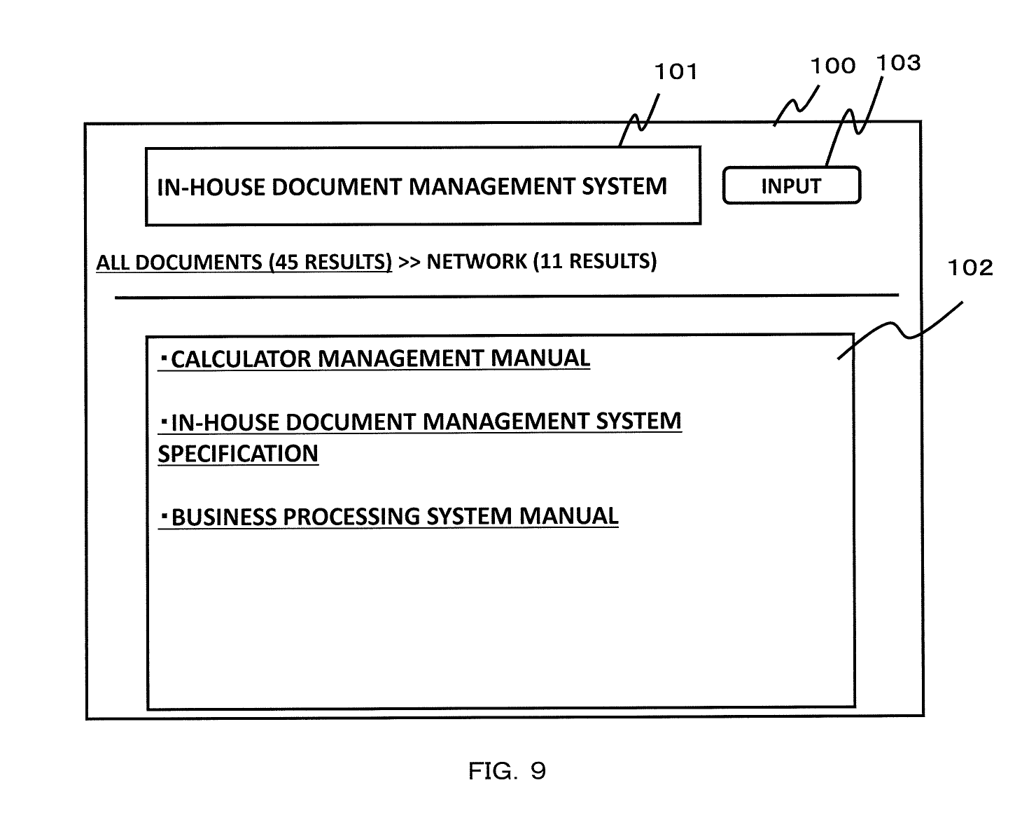

FIG. 9 shows one example of the output unit 15 in which search results in the full-text search mode are displayed in the format of list display. Specifically, FIG. 9 shows one example of the search screen 100 displayed on the output unit 15 in the case where the input character string “in-house document management system” inputted through the document input unit 11 by the user is inputted and where the document search process is performed.

The search screen 100 shown in FIG. 9 corresponds to the case where the search type is “full-text search” and where the display format is “list display.” Results of a search are displayed in the search result display area 102 in the form of a list of document titles, which are links to the respective main bodies of the documents. The user can select one of the document titles displayed in the search result display area 102 to browse the document. Further, the user can perform another search by inputting a character string to the input form 101 again and sending the character string.

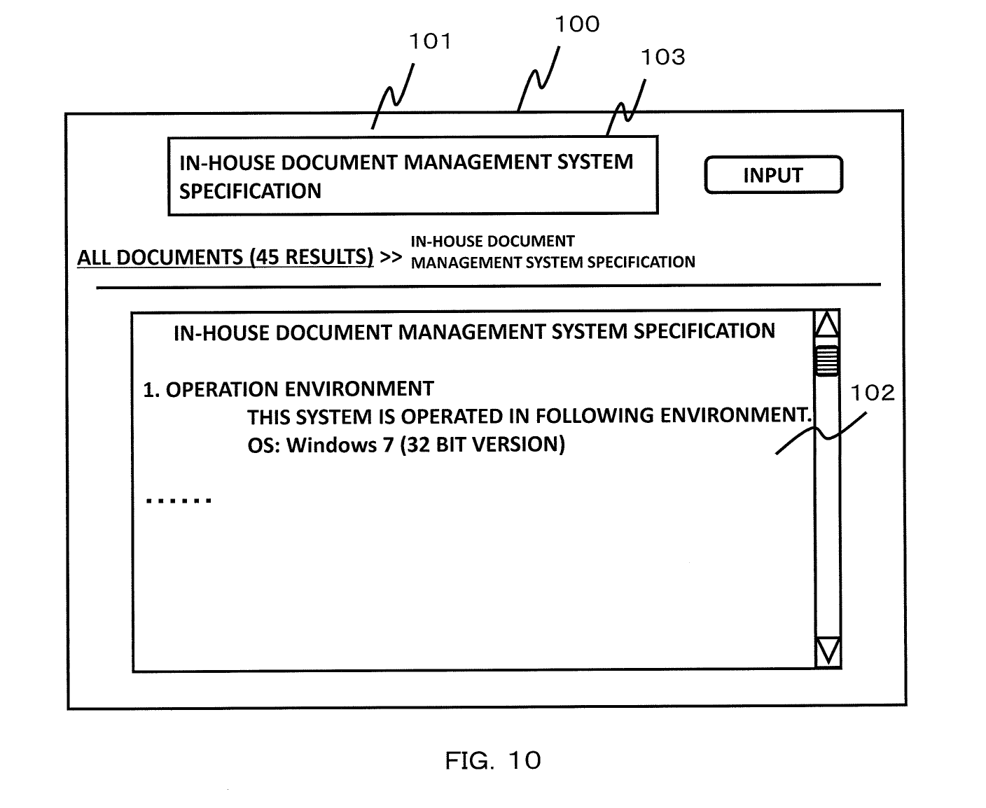

FIG. 10 shows one example of a screen displayed on the output unit 15 which displays search results in a search mode where a search is narrowed down to a single document using a search formula. In other words, FIG. 10 shows a screen displayed on the output unit 15 after the character string “in-house document management system specification” being inputted to the input form 101 and the input button 103 being clicked. The input unit 11 of this embodiment creates a search formula “/doc/header/title=‘in-house document management system specification’” based on the phrase inputted to the input form 101, and performs a search. As a result of the search, data on the document “in-house document management system specification,” which is identical to the input character string, is displayed as a search result in the search result display area 102. It should be noted that in FIG. 10, not a link to the main body of the document “in-house document management system specification” but the main body is directly displayed. In the case where the user requests another document, when another character string is inputted to the input form 101, another search is performed.

As described above, the document searching system of this embodiment can perform an appropriate search based on the attribute of an inputted phrase, and therefore can perform an efficient search. Further, the document searching system of this embodiment can perform appropriate outputting of search results, and therefore can improve user's work efficiency.

### Description of the Second Embodiment

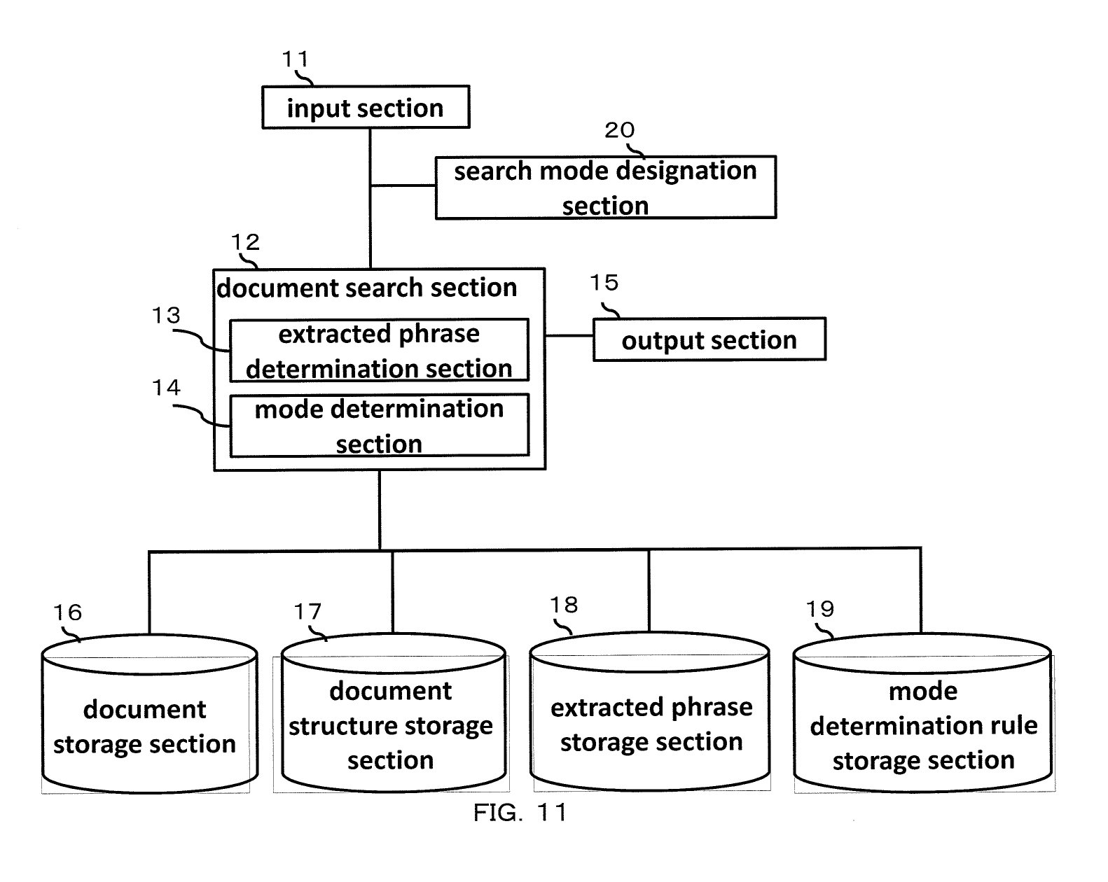

FIG. 11 shows a schematic configuration of a document searching system according to a second embodiment of the present invention. It should be noted that the same portions as those of the first embodiment are denoted by the same reference numerals, and will not be further described.

As shown in FIG. 11, the document searching system according to this embodiment further includes a search mode designation unit 20 in addition to the configuration of the document searching system shown in FIG. 1.

The user designates a search mode using the search mode designation unit 20. Based on this search mode designated with the search mode designation unit 20, the document search unit 12 performs another search on the document storage unit 16.

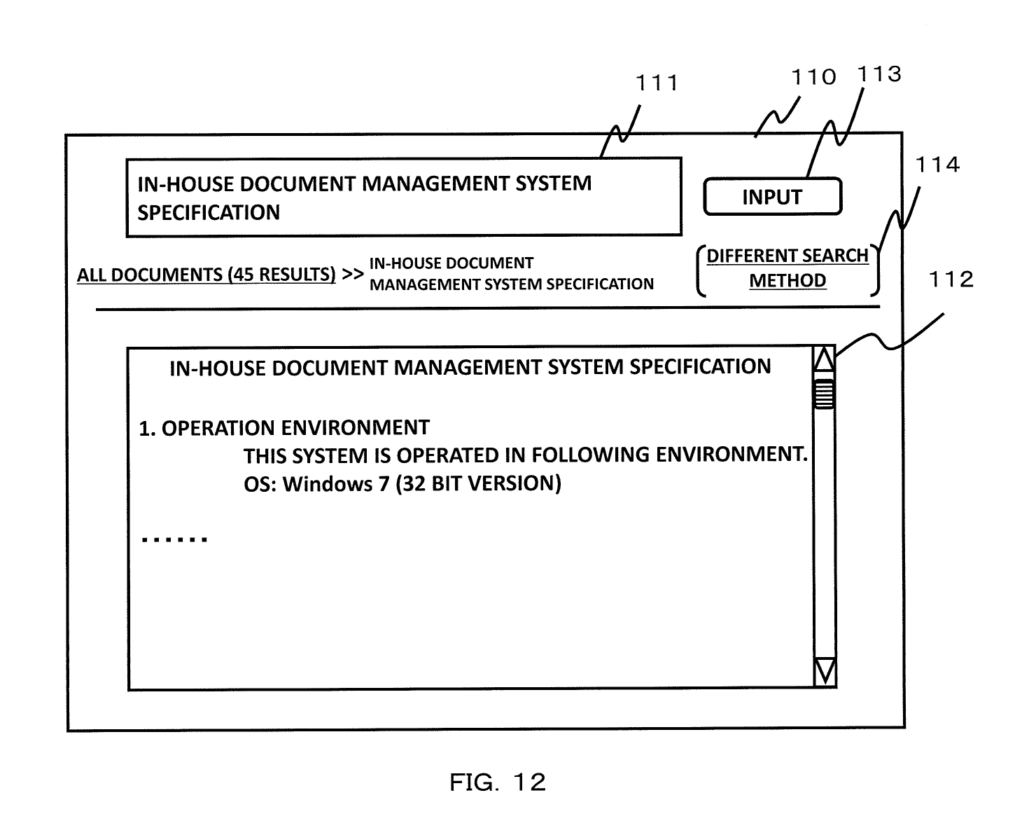

Referring to FIG. 12, one example of a search mode designation process by the search mode designation unit 20 will be described. A search screen 110 shown in FIG. 12 is in a state achieved after inputting the character string “in-house document management system specification” to the input form 110 by the user, clicking the input button 113, and inputting this input character string using the input unit 11. In a search result display area 112, the documents in the search results are displayed.

In the search screen 110 shown in FIG. 12, “in-house document management system specification” is extracted as a document name. Since a single document is extracted, the document in the search result is directly displayed.

In the searching system of this embodiment, in the case where a different search mode link 114 of FIG. 12 is selected by the user after the search mode present process of the first embodiment is performed, the search mode designation unit 20 performs the search mode designation process.

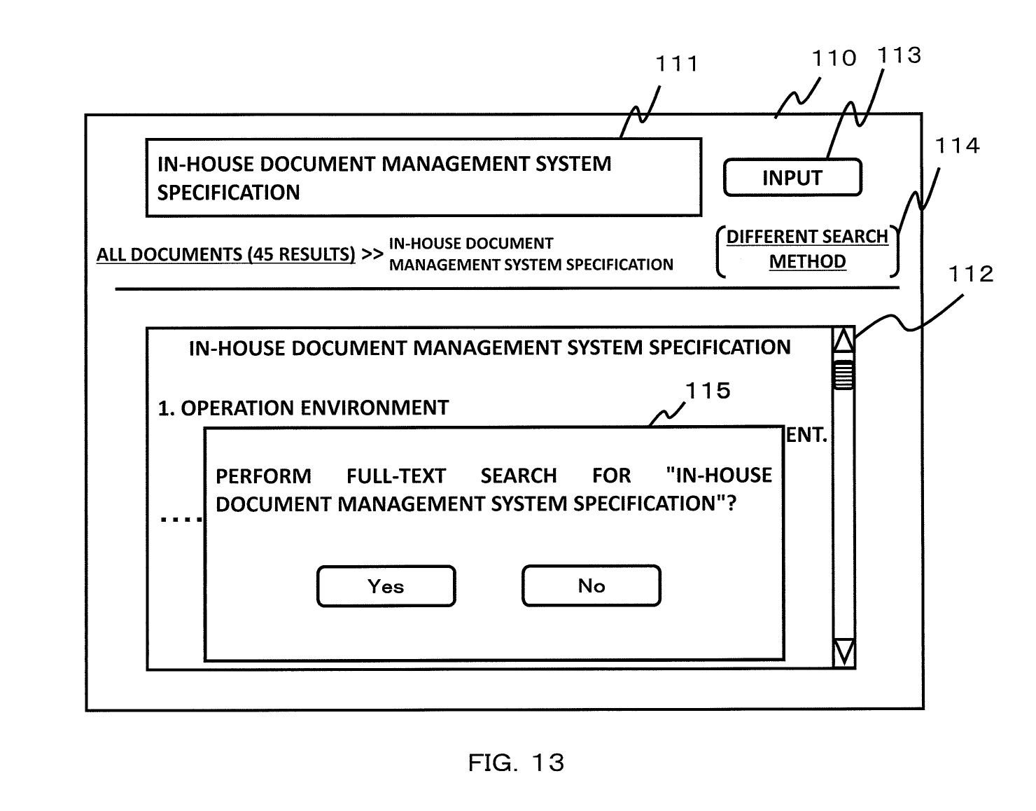

In other words, when the other search mode link 114 is selected by the user using the input unit 11, the search mode designation unit 20 displays a search mode selection area 115 in the form of a pop up window. FIG. 13 shows one example of the output unit 15 in which the search mode selection area 115 is displayed. In the output unit 15 shown in FIG. 13, “full-text search” is displayed as an example of a different search mode in the search mode selection area 115. In other words, a search mode other than the search mode selected in the search mode present process is displayed in the search mode selection area 115. If a “Yes” button is clicked here, a document search for “in-house document management system specification” is performed as a full-text search, which is another search mode.

As described above, with the document searching system of this embodiment, in the case where the user is not satisfied with search results, the search mode can be set again. Thus, the user can perform an efficient search.

### Description of the Third Embodiment

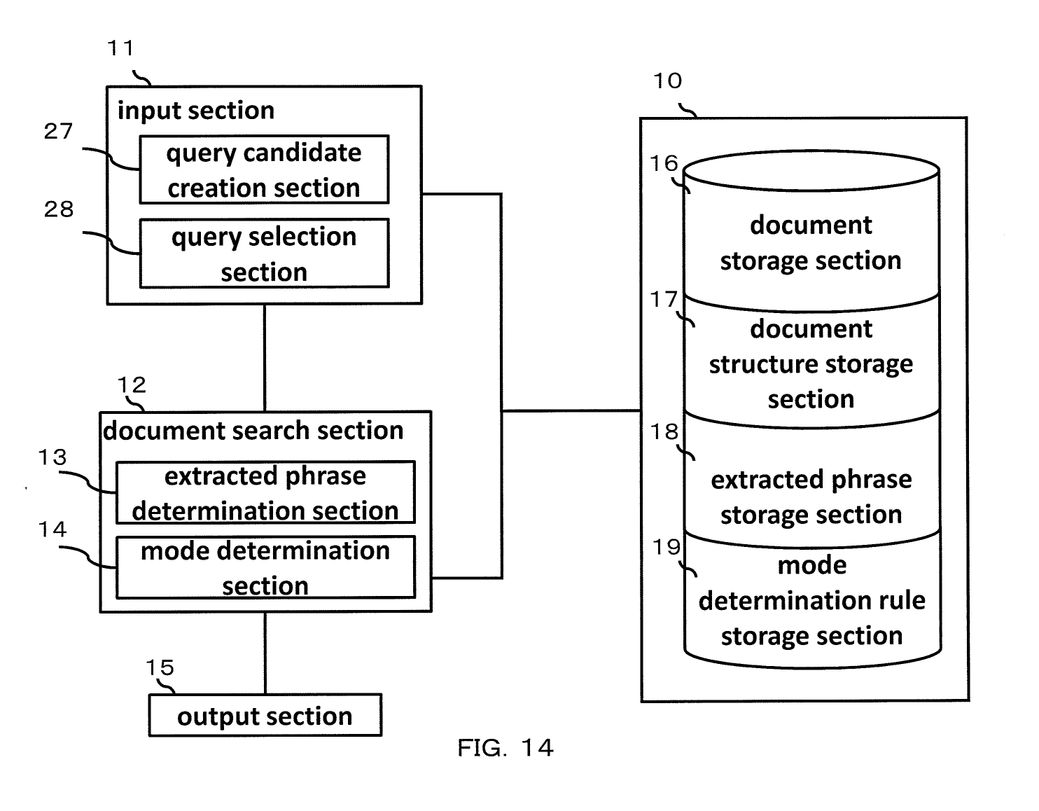

FIG. 14 shows a schematic configuration of a document searching system according to a third embodiment of the present invention. It should be noted that the same portions as those of the first embodiment are denoted by the same reference numerals, and will not be further described.

As shown in FIG. 14, the document searching system according to this embodiment further includes a query candidate creation unit 27 and a query selection unit 28 in addition to the configuration of the document searching system shown in FIG. 1.

The query candidate creation unit 27 creates candidates for a search query (hereinafter referred to as query candidates) corresponding to the input character string by the user. In other words, the query candidate creation unit 27 compares the input character string inputted through the input unit 11 and the written expression 302 or the reading 303 of the extracted phrase stored in the extracted phrase storage unit 18. The query candidate creation unit 27 sends as query candidates phrases determined to correspond to the input character string as a result of the comparison to the query selection unit 28.

When the document search unit 12 searches the document storage unit 16, the document searching system of this embodiment performs a search using a query selected through the query selection unit 28 by the user from the query candidates created by the query candidate creation unit 27.

It should be noted that as in the first embodiment, the extracted phrases stored in the extracted phrase storage unit 18 of this embodiment are extracted by an unillustrated phrase extraction section from the document data stored in the document storage unit 16.

The phrase extraction section of this embodiment performs each of morphological analysis, named entity extraction, and compound word extraction on the entire range of the document data stored in the document storage unit 16, and extracts phrases having a specific word class and semantic attribute from respective results thereof. The phrase extraction section assigns to each of phrases extracted by such publicly-known approaches a pair (document ID, attribute) of the document ID of the extraction source and the attribute of the extracted phrase in this extraction source document.

The query candidate creation unit 27 compares the input character string received from the input unit 11 and the written expression 302 or reading 303 of each of the phrases stored in the extracted phrase storage unit 18 to determine whether or not the input character string corresponds to each phrase. If there is a phrase determined to correspond to the input character string, the query candidate creation unit 27 sends the phrase as a query candidate to the query selection unit 28. It should be noted that the timing with which the query candidate creation unit 27 receives the input character string from the input unit 11 is, for example, the timing with which the user clicks the input button using the input unit 11. Alternatively, this timing may be the timing with which a specific number of characters have been inputted or the timing with which a predetermined length of time has elapsed during the input.

If the written expression 302 or reading 303 of the input character string matches that of a phrase stored in the extracted phrase storage unit 18, the query candidate creation unit 27 determines that they correspond to each other. Further, for example, the following may be determined to correspond to the input character string: a phrase having a written expression or a reading which partially includes the input character string, a phrase having a written expression similar to that of the input character string, a phrase closely related to the input character string semantically or statistically, and the like.

For example, in the case where query candidates are created from phrases each having the written expression 302 or the reading 303 of which beginning matches that of the input character string, when the query candidate creation unit 27 receives “SH,” phrases such as the following in the extracted phrase storage unit 18 of which readings 303 begin with “SH” are extracted as query candidates: “in-house document management (SHANAI BUNSYO KANRI),” “in-house document search (SHANAI BUNSYO KENSAKU),” “in-house document management system specification (SHANAI BUNSYO KANRI SHISUTEMU SHIYOUSYO),” “method for selecting in-house document (SHANAI BUNSYO NO SENTAKU HOUHOU),” and the like . It should be noted that in the case where the number of query candidates is large, prioritization may be performed by the term frequency-inverse document frequency weighting scheme (tf-idf weighting scheme) or the like to narrow down the search to a predetermined number of query candidates. Further, in this case, a query candidate having a written expression 302 in which a predetermined number or proportion of beginning characters are the same as those of a high-priority query candidate may be eliminated.

Then, using the input unit 11, the user selects a query from the query candidates created by the query candidate creation unit 27. The selected query is sent to the query selection unit 28. The query selection unit 28 performs a query selection process based on the received query, and sends the selected query along with a result of the process to the document search unit 12.

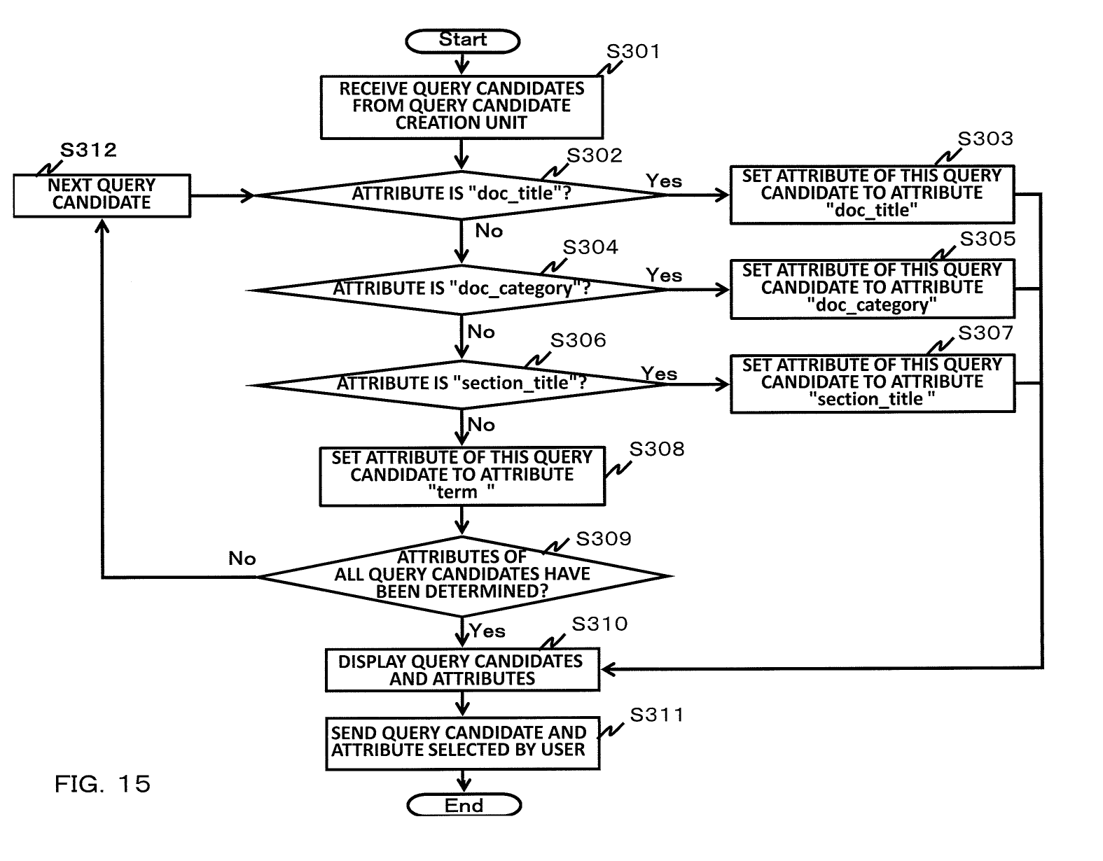

Referring now to FIG. 15, one example of the query selection process by the query selection unit 28 will be described. FIG. 15 is a flowchart showing one example of the query selection process.

First, the query selection unit 28 receives the query candidates created by the query candidate creation unit 27 and the attributes thereof (step S301). The query selection unit displays the pairs of received query candidates and attributes thereof to the user. Based on these query candidates and the attributes of these query candidates, the user selects a query candidate to be searched for.

At this time, there are cases where there is a plurality of attributes corresponding to a query candidate received by the query selection unit 28. In this case, all of the pairs of the query candidate and the attribute thereof may be displayed to the user. Alternatively, one representative attribute may be selected for each query candidate to display a pair of the query candidate and the attribute thereof. In this embodiment, in steps S302 to S308 of FIG. 15, the query selection unit 28 performs the process (hereinafter referred to as a representative attribute selection process) of selecting a representative attribute of a query candidate.

First, the query selection unit 28 determines whether or not the attributes of the received query candidate include “doc_title” (step S302).

If the attributes of the query candidate include “doc_title” (Yes in step S302), the query selection unit 28 determines that the attribute of the query candidate is “doc_title” (step S303).

If the received attributes of the query candidate include no “doc_title” (No in step S302), the query selection unit 28 determines whether or not the attribute of the query candidate includes “doc_category” (step S304).

If the attributes of the query candidate include “doc_category” (Yes in step S304) , the query selection unit 28 determines that the attribute of the query candidate is “doc_category” (step S305).

If the attributes of the query candidate do not include “doc_category” (No in step S304), the query selection unit 28 determines whether or not the attributes of the query candidate include “section_title” forming a predetermined proportion of all the attributes assigned to the query candidate (step S306). In other words, if the attribute “section_title” forms less than the predetermined proportion, it is determined as “No” in step S306. It should be noted that this predetermined proportion is set in advance.

If “section_title” forms the predetermined proportion of the attributes of the query candidate (Yes in step S306), the query selection unit 28 determines that the attribute of the query candidate is “section_title” (step S307).

If “section_title” does not form the predetermined proportion of the attributes of the query candidate (No in step S306), the query selection unit 28 determines that the attribute of the query candidate is term (step S308).

If the representative attribute selection process has not been performed on all the query candidates received from the query candidate creation unit 27 (No in step S309), the representative attribute selection process is started for a subsequent query candidate (step S312).

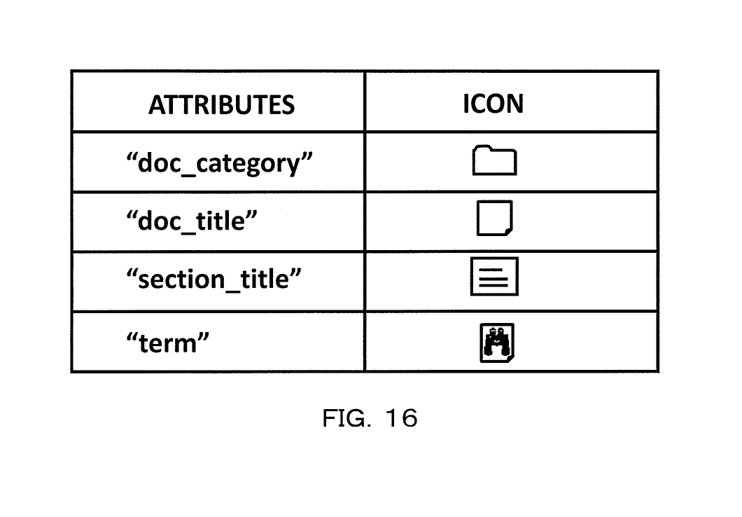

If the representative attribute selection process has been performed on all the query candidates received from the query candidate creation unit 27 (Yes in step S309) , the query selection unit 28 displays to the user the query candidates and the attributes thereof in a relational manner (step S310). In this case, the display may be made on a display as the output unit 15. It should be noted that in this example, the attributes are expressed by icons to be displayed. FIG. 16 shows one example of respective icons representing attributes in this embodiment.

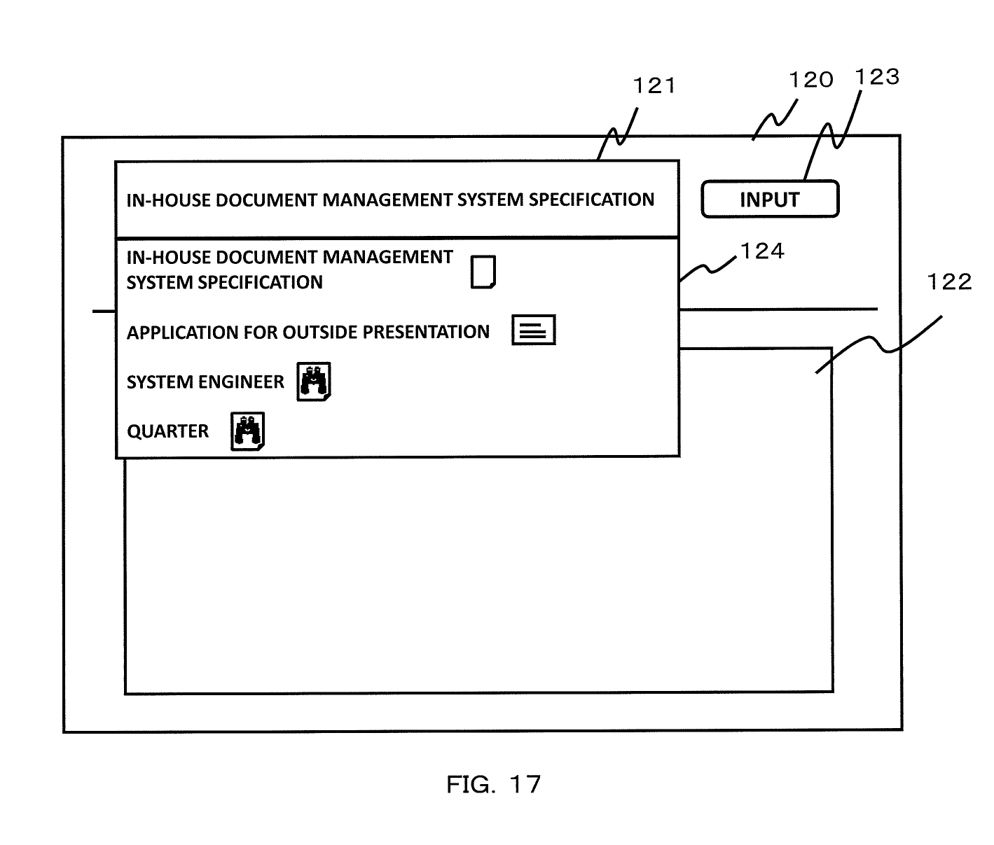

FIG. 17 shows one example of a screen for displaying a list of query candidates and the attributes thereof to the user. FIG. 17 is one example of a search screen 120, which includes an input form 121, a search result display area 122, an input button 123, and a query candidate display area 124. The input form 121, the search result display area 122, and the input button 123 have functions similar to those of the input form 101, the search result display area 102, and the input button 103 in the search screen 100 of the first embodiment.

The query candidate display area 124 is an area for displaying query candidates and the attributes thereof in a relational manner to the user in step S310. In FIG. 17, “in-house document management system specification (SHANAI BUNSYO KANRI SHISUTEMU SHIYOUSYO),” “application for outside presentation (SHAGAI HAPPYOU SHINSEI),” “system engineer (SHISUTEMU ENGINIA),” and “quarter (SHIHANKI)” are displayed as query candidates. The attribute of “in-house document management system specification(SHANAI BUNSYO KANRI SHISUTEMU SHIYOUSYO)” is “doc_title,” the attribute of “application for outside presentation (SHAGAI HAPPYOU SHINSEI)” is “section_title,” and the attributes of “system engineer (SHISUTEMU ENGINIA)” and “quarter(SHIHANKI)” are “term.”

When the user selects one from phrases which are the query candidates displayed in the query candidate display area 124, the query selection unit 28 sends the selected query candidate and the attribute thereof to the document search unit 12 (step S311).

When the document search unit 12 receives the phrase as a query candidate and the attribute thereof from the query selection unit 28, the search mode determination unit 14 executes a search mode determination process shown in FIG. 8 based on the phrase as the query candidate received from the query selection unit 28 and the attribute thereof. Then, the document search unit 12 executes a document search based on the result of the determination by the mode determination unit 14. The output unit 15 outputs search results by the document search unit 12.

As described above, with the document searching system of this embodiment, query candidates corresponding to characters inputted by the user can be presented. In other words, the user can execute a document search by selecting a presented candidate without inputting an entire character string to be searched for. Thus, the user's labor of inputting characters can be reduced.

Further, when a search is executed by the method as described above, information on search process types applicable to each candidate outputted is disclosed to the user. Accordingly, the user can actively perform candidate selection based on the type of a search process to be performed after that, such as a search process in which the search is narrowed down directly to a single document.

### Description of the Fourth Embodiment

A document searching system of this embodiment has a configuration similar to that of the document searching system of the third embodiment.

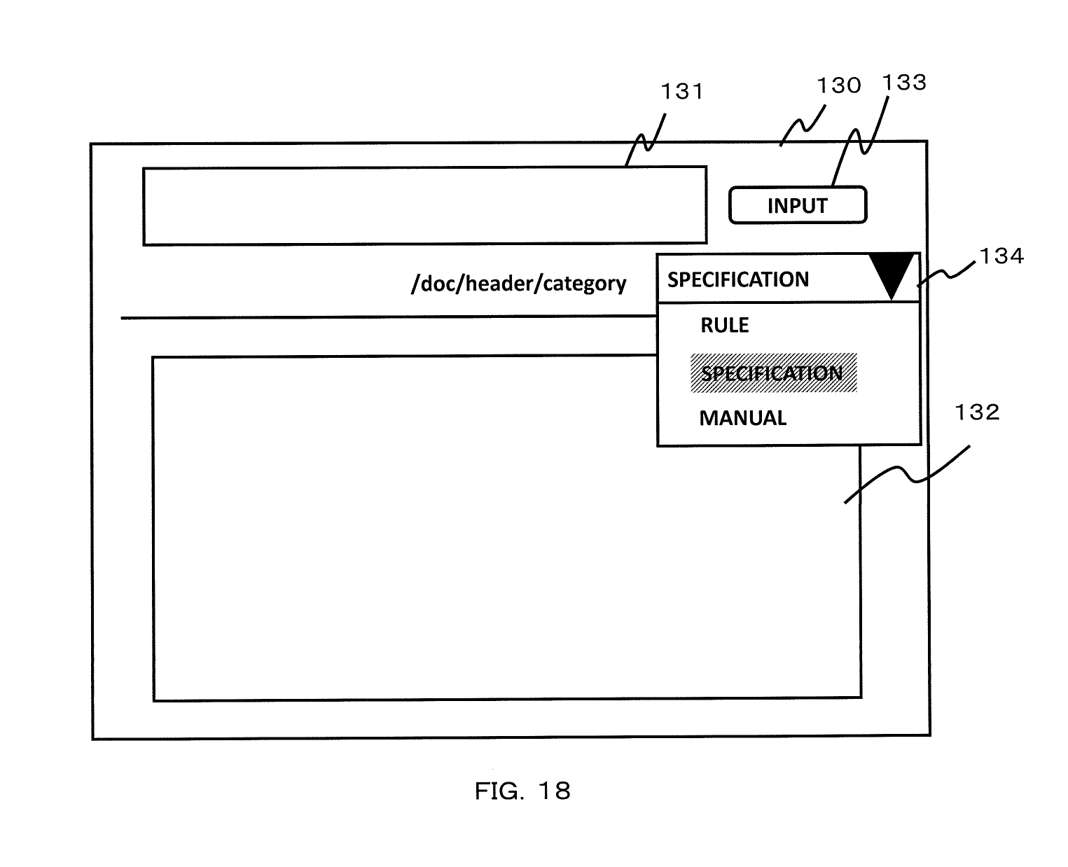

FIG. 18 shows one example of a search screen 130 displayed when the user inputs a phrase to be searched for using the input unit 11 of the document searching system according to the fourth embodiment.

The search screen 130 shown in FIG. 18 is the search screen 130 for a category search. The search screen 130 includes an input field 131 to be used by the user to input a phrase for a document search, and a menu 134 for inputting a phrase (hereinafter referred to as a narrowing phrase) used to narrow down documents to be searched based on phrases in “/doc/header/category” of the document data. In other words, in the document searching system of this embodiment, the user inputs the narrowing phrase to the menu 134 of the input screen 130 for a category search using the input unit 11.

In other words, documents to be searched are narrowed down based on the narrowing phrase inputted through the input unit 11. In this example, documents to be searched are narrowed down to a set of documents which have the same category as the inputted narrowing phrase. Specifically, for example, the extracted phrase information 300 is referred to based on the narrowing phrase inputted to the menu 134 by the user using the input unit 11, and extraction source document IDs 305 corresponding to documents in which the attribute 306 of the narrowing phrase is “doc_category” are set as a group of documents to be searched.

It should be noted that the narrowing phrase may be inputted directly to the menu 134 by the user using the input unit 11, or extracted phrases which are contained in the extracted phrase information 300 stored in the extracted phrase storage unit 18 and of which attributes 306 include “doc_category” may be displayed in the menu 134 to allow the user to make a selection using the input unit 134.

As shown in FIG. 18, in the document searching system of this embodiment, the extracted phrases “rule,” “specification,” and “manual” which are contained in the extracted phrase information 300 stored in the extracted phrase storage unit 18 and of which attributes 306 include “doc_category” are displayed under the menu 134. It is assumed that the user select the category “specification” marked by hatching, using the input unit 11.

Based on the designated category, the query candidate creation unit 27 creates query candidates. In other words, query candidates in the category designated by the user are created. The created query candidates are sent to the query selection unit 28, and the user selects one from the query candidates through the query selection unit 28 to perform a document search.

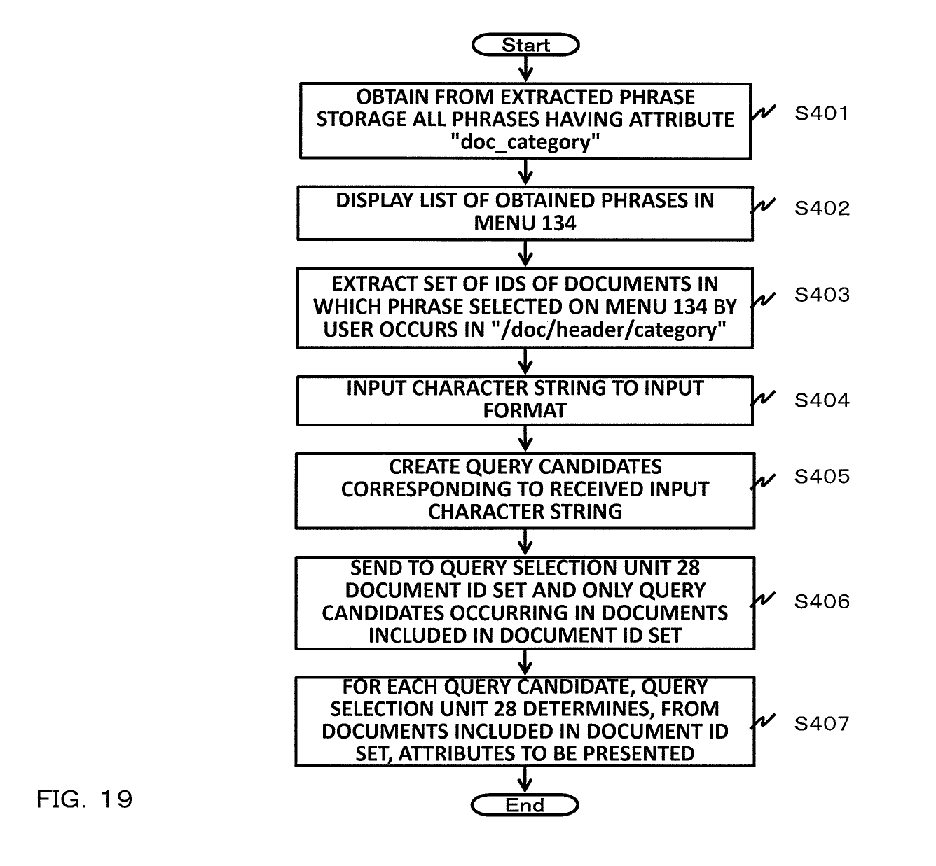

Referring now to FIG. 19, the operation of the document searching system of this embodiment will be described. FIG. 19 is a flowchart showing one example of a query candidate creation process in the document searching system of this embodiment.

It should be noted that in this example, when the user clicks the menu 134 in the input screen 130 for a category search using the mouse as the input unit 11, the query candidate creation process is started.

When the user clicks the menu 134 using the input unit 11, the query candidate creation unit 27 obtains the extracted phrase information 300 on all phrases having the “doc_category” attribute from the extracted phrase storage unit 18 (step S401). As shown in FIG. 18, the query candidate creation unit 27 displays the obtained phrases under the menu 134 in the form of a list (step S402).

When the user selects one phrase from a list of phrases displayed in step 5402 using the mouse as the input unit 11, the document search unit 12 extracts the document IDs 305 of documents in which the phrase inputted through the menu 134 occurs in “/doc/header/category” (step S403). At this time, the document search unit 12 can be implemented by, for example, obtaining the document ID 305 stored in a pair with the attribute “doc_category” in the extracted phrase information 300 on the selected phrase in the extracted phrase storage unit 18.

The user inputs a character string to be searched for to the input field 131 using the input unit 11 (step S404). The query candidate creation unit 27 creates query candidates corresponding to the inputted character string (step S405). Of the created query candidates, only query candidates occurring in documents corresponding to a set of document IDs are sent to the query selection unit 28 along with the set of document IDs (step S406). Specifically, for example, only the query candidates created instep S405 in which the extraction source document IDs 305 in the extracted phrase information 300 include the document IDs 305 extracted in step S405 are set as query candidates.

The query selection unit 28 refers to the extracted phrase information 300 on the set of document IDs for each of the received query candidates, and performs the attribute determination process corresponding thereto (step S407).

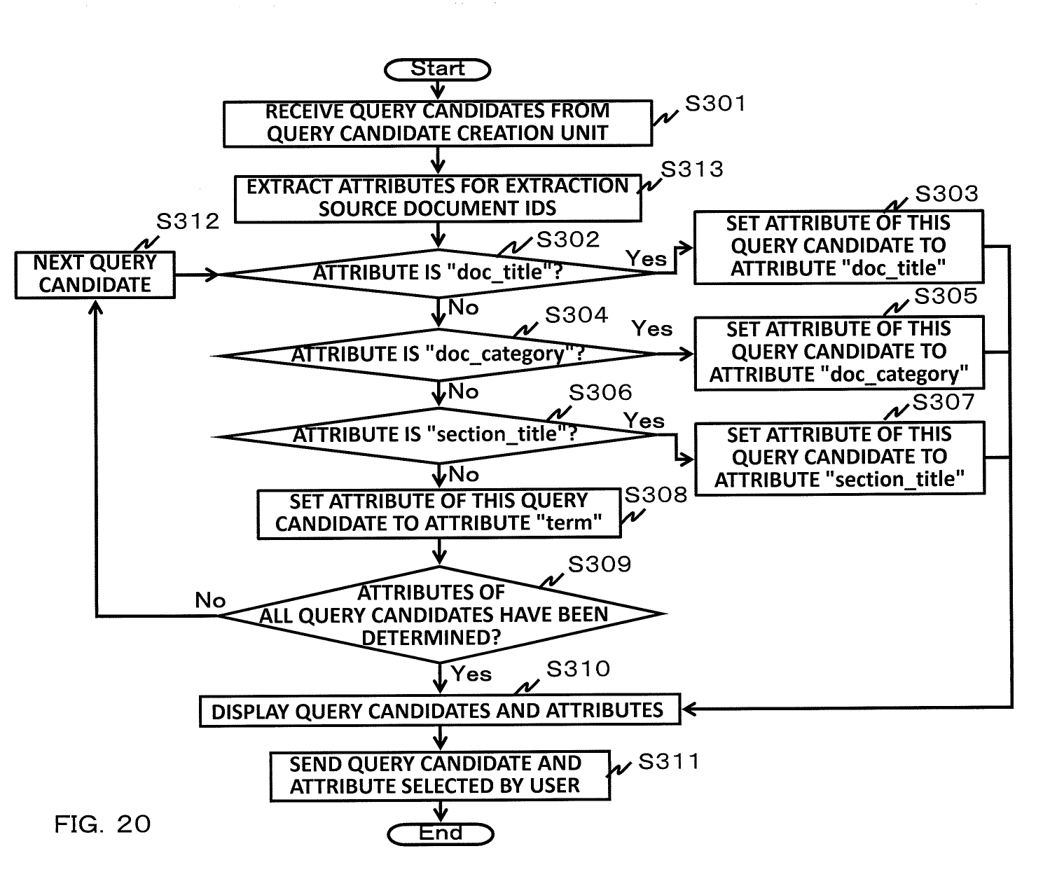

Further, the query selection unit 28 of this embodiment determines the attribute for each of the query candidates received from the query candidate creation unit 27 among the attributes for the document IDs 305 extracted in step S405, and performs the query selection process . As shown in FIG. 20, step S313 is added between steps S301 and S302 of FIG. 15 to extract only the attributes in the group of document IDs extracted in step S405 from the extracted phrase information 300 on the received query candidates, thus performing the processing of steps S302 to S308 of FIG. 15 on the extracted attributes. The query candidates created by the query selection unit 28 of this embodiment are displayed under the input field 131.

The document searching system of this embodiment performs a document search by narrowing, based on categories, data on documents to be searched and allowing the user to select the query candidates created from the narrowed document data. Accordingly, the document searching system of this embodiment makes it possible to perform an efficient search. In other words, with the document searching system of this embodiment, search results can be further narrowed down by performing a search in such a manner that data on documents to be searched are narrowed down based on categories. Thus, it is easy to directly display data on the documents in the search results to the user. It should be noted that narrowing can also be performed based on an attribute other than category.

Although embodiments of the present invention have been described above, these embodiments are presented as examples and not intended to limit the scope of the invention. These novel embodiments can be carried out in other various ways, and various omissions, substitutions, and alterations can be made without departing from the spirit of the invention. These embodiments and modifications thereof are included in the scope and spirit of the invention as well as in the scope of the invention defined in the appended claims and equivalents thereof.

What is claimed is: <Apparatus Claims>

1. A document searching system comprising:
a storage device storing structured document data, extracted phrase information of phrases in the structured document data which includes an identifier of the extraction-source structured document data containing each of the phrases and includes an attribute of each of the phrases in the extraction-source structured document data, and a mode determination rule including a search mode and a display format for each attribute;
a character input section for inputting a search phrase;
a determination section for, if the extracted phrase information contains a phrase matching the search phrase, determining an attribute of the search phrase with reference to the extracted phrase information, and determining a search mode for searching the structured document data and a display format of a search result with reference to the mode determination rule based on the determined attribute;
a document search section for searching the structured document data based on the search phrase in the determined search mode; and
an output section for outputting a search result obtained by the document search section in the determined display format.

2. The document searching system according to claim 1, wherein the determination section sets the display format to document direct display if there is only one identifier of the structured document data corresponding to the determined attribute.

3. The document searching system according to claim 1, further comprising:
a search mode designation section for designating a search mode other than the search mode determined by the determination section, wherein the document search section performs a search based on the search mode designated by the search mode designation section.

4. The document searching system according to claim 1, further comprising:
a query candidate creation section for searching the extracted phrase information based on an input character inputted through the character input section, and creating a candidate for a search query; and
a query selection section for determining an attribute of the created query candidate with reference to the extracted phrase information, presenting the query candidate and the attribute in a relational manner to a user, and sending the query candidate and the attribute selected by the user to the document search section, wherein
the document search section sets the query candidate sent from the query selection section as the search phrase, determines the search mode with reference to the mode determination rule based on the attribute sent from the query selection section, and searches the structured document data in the determined search mode.

5. The document searching system according to claim 1, wherein the input section receives a narrowing phrase,
the document search section narrows down the structured document data based on the narrowing phrase, and searches the narrowed structured document data based on the search phrase in the determined search mode.
<Method Claims>

6. A document searching method in a document searching system comprising a storage device storing structured document data, extracted phrase information of phrases in the structured document data which includes an identifier of the extraction-source structured document data containing each of the phrases and includes an attribute of each of the phrases in the extraction-source structured document data, and a mode determination rule including a search mode and a display format for each attribute, the document searching method comprising the steps of:
inputting a search phrase;
if the extracted phrase information contains a phrase matching the search phrase, determining an attribute of the search phrase with reference to the extracted phrase information, and determining a search mode for searching the structured document data and a display format of a search result with reference to the mode determination rule based on the determined attribute;
searching the structured document data based on the search phrase in the determined search mode; and
outputting a search result obtained in the searching step in the determined display format.

7. The document searching method according to claim 6, further comprising the step of
setting the display format to document direct display if there is only one identifier of the structured document data corresponding to the determined attribute.

8. The document searching method according to claim 6, further comprising the steps of :
designating a search mode other than the determined search mode; and
performing a search based on the designated search mode.

9. The document searching method according to claim 6, further comprising the steps of:
searching the extracted phrase information based on an input character, and creating a candidate for a search query;
determining an attribute of the created query candidate with reference to the extracted phrase information;
presenting the query candidate and the attribute in a relational manner to a user, and setting the query candidate selected by the user as the search phrase; and
determining the search mode with reference to the mode determination rule based on the attribute, and searching the structured document data in the determined search mode.
<Program Claims>

10. A storage medium storing a document searching program for a document searching system comprising a storage device storing structured document data, extracted phrase information of phrases in the structured document data which includes an identifier of the extraction-source structured document data containing each of the phrases and includes an attribute of each of the phrases in the extraction-source structured document data, and a mode determination rule including a search mode and a display format for each attribute, the program causing a computer to execute the functions of:
inputting a search phrase;
if the extracted phrase information contains a phrase matching the search phrase, determining an attribute of the search phrase with reference to the extracted phrase information, and determining a search mode for searching the structured document data and a display format of a search result with reference to the mode determination rule based on the determined attribute;
searching the structured document data based on the search phrase in the determined search mode; and
outputting a search result obtained by the document search section in the determined display format.

11. The program according to claim 10, further causing the computer to execute the function of:
setting the display format to document direct display if there is only one identifier of the structured document data corresponding to the determined attribute.

12. The program according to claim 10, further causing the computer to execute the functions of:
designating a search mode other than the determined search mode; and
performing a search based on the designated search mode.

13. The program according to claim 10, further causing the computer to execute the functions of:
searching the extracted phrase information based on an input character, and creating a candidate for a search query;
determining an attribute of the created query candidate with reference to the extracted phrase information;
presenting the query candidate and the attribute in a relational manner to a user, and setting the query candidate selected by the user as the search phrase; and
determining the search mode with reference to the mode determination rule based on the attribute, and searching the structured document data in the determined search mode.
